(19) United States
(12) Patent Application Publication
(10) Pub. No.: US 2025/0224496 A1
(43) Pub. Date: Jul. 10, 2025

(54) TIME-OF-FLIGHT DEMODULATION CIRCUITRY AND TIME-OF-FLIGHT DEMODULATION METHOD

(71) Applicant: Sony Semiconductor Solutions Corporation, Atsugi-shi, Kanagawa (JP)

(72) Inventors: Daniel VAN NIEUWENHOVE, Stuttgart (DE); Maarten KUIJK, Stuttgart (DE)

(73) Assignee: Sony Semiconductor Solutions Corporation, Atsugi-shi, Kanagawa (JP)

(21) Appl. No.: 18/844,393

(22) PCT Filed: Feb. 21, 2023
(86) PCT No.: PCT/EP2023/054279

§ 371 Date: Sep. 6, 2024

(30) Foreign Application Priority Data
Mar. 16, 2022 (EP) 22162473.7

(51) Int. Cl. G01S 7/4865; G01S 17/18; G01S 17/894

(52) U.S. Cl. CPC G01S 7/4865; G01S 17/18; G01S 17/894

(57) ABSTRACT

The present disclosure generally pertains to time-of-flight demodulation circuitry configured to: carry out a first determination and a second determination, the first determination including: integrating a light signal demodulated with a first mixing signal into a first integrated demodulated signal; and set a selection signal for disabling detection of light, the selection signal being set based on the first integrated demodulated signal for integrating, in the second determination, the light signal demodulated with a second mixing signal into a second integrated demodulated signal for a shorter time period than in the first determination; the second determination including: integrating the light signal demodulated with the second mixing signal into the second integrated demodulated signal based on the selection signal.

### TECHNICAL FIELD

The present disclosure generally pertains to time-of-flight demodulation circuitry and a time-of-flight demodulation method.

### TECHNICAL BACKGROUND

Generally, time-of-flight (ToF) cameras are known.

It may be distinguished between indirect ToF (iToF) and direct ToF (dToF).

In iToF, a phase-shift of emitted light is measured with a demodulation signal and the phase-shift is indicative of a distance from the camera to the object. Current-assisted photonic demodulators (CAPDs) may be used for carrying out an iToF measurement.

In dToF, the distance is directly measured by measuring a time of flight which emitted light needs to return to the camera after reflection at a scene (e.g. an object or region of interest). Basically, dToF is based on a counting of photons and assigning the counted photons to a time bin in a histogram, wherein the time bin may correspond to a time period after emission of light (by a respective pulsed light source, for example).

Although there exist techniques for carrying out a ToF measurement it is generally desirable to provide time-of-flight light event detection circuitry and a time-of-flight light event detection method.

### SUMMARY

According to a first aspect, the disclosure provides time-of-flight demodulation circuitry configured to:
carry out a first determination and a second determination, the first determination comprising:
   integrating a light signal demodulated with a first mixing signal into a first integrated demodulated signal; and
   set a selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination comprising:
   integrating the light signal demodulated with the second mixing signal into the second integrated demodulated signal based on the selection signal.

According to a second aspect, the disclosure provides a time-of-flight demodulation method comprising:
carrying out a first determination and a second determination, the first determination including:
   integrating a light signal demodulated with a first mixing signal into a first integrated demodulated signal; and
   setting a selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination including:
   integrating the light signal demodulated with the second mixing signal into the second integrated demodulated signal based on the selection signal.

According to a third aspect, the disclosure provides a time-of-flight device comprising:
a light source;
at least one light detection element configured to generate an electric signal in response to a detection of light being emitted from the light source and reflected at a scene, the light detection element comprising an overflow gate configured to selectively disable the detection of light by applying a selection signal; and
time-of-flight demodulation circuitry configured to:
carry out a first determination and a second determination, the first determination comprising:
   integrating the light signal demodulated with a first mixing signal into a first integrated demodulated signal; and
   set the selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination comprising:
   integrating the light signal demodulated with the second mixing signal into the second integrated demodulated signal based on the selection signal.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts an embodiment of a timing diagram according to the present disclosure, wherein demodulation signals are applied according to a Gray code;

FIG. 2 depicts a further embodiment of a timing diagram according to the present disclosure, wherein demodulation signals are applied according to a digital (binary) sequence;

FIG. 3 depicts a further timing diagram according to the present disclosure with three consecutive detections and including a readout current;

FIG. 4 depicts an embodiment of a ToF demodulation method according to the present disclosure in a flow diagram;

FIG. 5 depicts, in FIGS. 5A to 5C, ToF demodulation circuitry according to the present disclosure with demodulation signals, selection signals and reference signals applied to the ToF demodulation circuitry;

FIG. 6 depicts embodiments of a ToF pixel according to the present disclosure and programming states of the OFG for the four consecutive detection described in the timing diagram of FIG. 2;

FIG. 7A depicts ToF demodulation circuitry corresponding to ToF demodulation circuitry of FIG. 5A and additionally including a frequency generator;

FIG. 7B shows a timing diagram an overflow gate the ToF demodulation circuitry of FIG. 7A;

FIG. 8 depicts an embodiment of a ToF pixel according to the present disclosure;

FIG. 9 depicts an embodiment of a ToF pixel according to the present disclosure;

FIG. 10 depicts an embodiment of a ToF demodulation circuitry according to the present disclosure with demodulation signals, selection signals and reference signals applied to the ToF demodulation circuitry

FIG. 11 illustrates an embodiment of a ToF imaging system according to the present disclosure;

FIG. 12 depicts a block diagram of an embodiment of a ToF demodulation method according to the present disclosure;

FIG. 13 depicts a block diagram of a further embodiment of a ToF demodulation method according to the present disclosure including a further demodulation; and

FIG. 14 is a schematic diagram in which the results of the present disclosure are compared to known ToF devices.

### DETAILED DESCRIPTION OF EMBODIMENTS

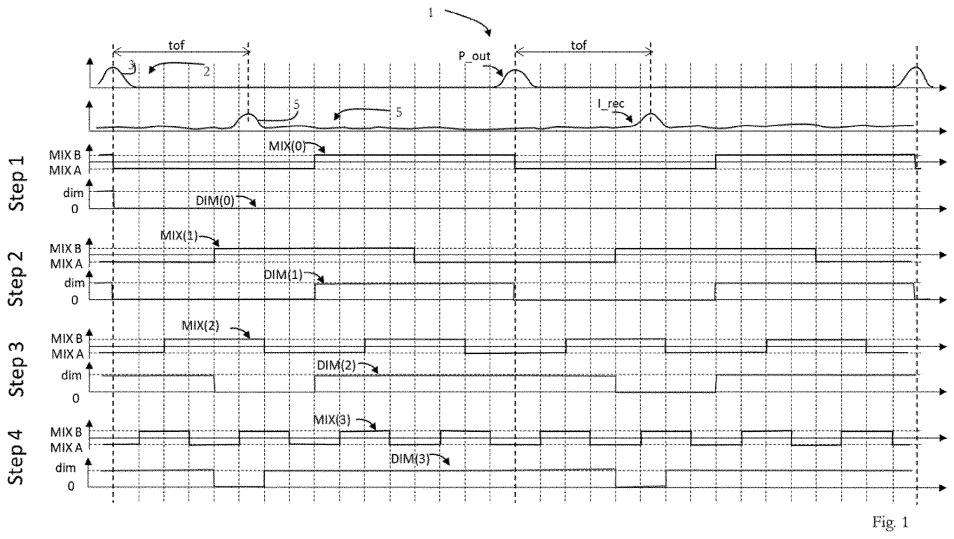

Before a detailed description of the embodiments starting with FIG. 1 is given, general explanations are made.

As mentioned in the outset, time-of-flight (ToF) devices are generally known.

However, in known devices a signal to noise ratio (SNR) may be considered as insufficient. It has been recognized that it is possible to reduce the noise when a demodulation signal (which is known for iToF) captures a light pulse signal (as in dToF), wherein the demodulation signal may be ideally as long or only a bit longer than the light pulse is wide (in time), such that an integration time may be reduced (and thus, less ambient light is detected). Hence, it has been recognized that it is desirable to predict when the light pulse will arrive again (after reflection at the scene), such that the demodulation signal can be adapted (timed) accordingly.

Hence, according to the present disclosure, principles of iToF and dToF may be combined and perks of one may compensate for drawbacks of the other. For example, iToF may have a high resolution, but a low SNR in high ambient light conditions, whereas dToF may have a high SNR, but a low resolution. According to the present disclosure, a high resolution and a high SNR may be achieved in some embodiments. Moreover, some embodiments pertain to the automotive field, to the production of Bokeh effect, or the like, since, e.g., a quick distance measurement is possible, which may be used for fast Bokeh effect generation, for fast object detection in automotive, etc.

It has further been recognized that, for reducing noise, an integration time can be shortened in some embodiments while still capturing a reflected light pulse.

Therefore, some embodiments pertain to time-of-flight demodulation circuitry configured to: carry out a first determination and a second determination, the first determination including: integrating a light signal demodulated with a first mixing signal into a first integrated demodulated signal; and set a selection signal for disabling detection of light, the selection signal being set based on the first integrated demodulated signal for integrating, in the second determination, the light signal demodulated with a second mixing signal into a second integrated demodulated signal for a shorter time period than in the first determination; the second determination including: integrating the light signal demodulated with the second mixing signal into the second integrated demodulated signal based on the selection signal.

Circuitry may pertain to any entity of multitude of entities which can generate or control demodulation signals (which will be discussed further below), such as a CPU (central processing unit), GPU (graphics processing unit), FPGA (field-programmable gate array), or any type of integrated circuit (IC), or the like, wherein also combinations of such or other entities may be envisaged.

The circuitry may be configured to detect a light signal (pulse, modulated light, or the like) with different mixing (demodulation) signals.

The light signal may derive from a light source, for example, which may be based on (laser) diodes, such as VCSELs (vertical cavity surface emitting laser), or the like, and the light may be emitted to a scene (e.g. object, region of interest) of which a depth image or a distance should be determined. The light may be reflected at the scene and may be incident on at least one imaging element, wherein the total time of the light pulse's roundtrip may be called “time of flight” from which a distance to the scene may be determined.

The imaging element may be based on a photodiode, a CAPD (current-assisted photonic demodulator), gated ToF elements, or the like, such that a demodulation signal can be applied to it based on the ToF demodulation circuitry according to the present disclosure. Accordingly, the ToF demodulation circuitry may be configured to directly apply the demodulation signal(s) or may control further circuitry (e.g. an integrated circuit) to apply the demodulation signal(s) (MIX), wherein the ToF demodulation circuitry may provide the further circuitry with corresponding control signals including a signal shape, a timing, a frequency, or the like.

The imaging element may include a photo-detection element which may have a structure including at least two taps (e.g., TAP A and TAP B), wherein photo generated electrons may be drained through one of the taps in dependence on the demodulation signal(s) (MIX) applied to the respective tap. The operation of the taps with a demodulation signal (MIX) is exemplary repeated for a predetermined amount of periods (e.g. hundred, thousand, or the like).

In some embodiments, the ToF demodulation circuitry is implemented based on or may be configured to communicate with multiple TOF pixels in an array. In such an array, the demodulation signals (MIX) is global for all pixels and the selection signal (DIM) is set specific to each pixels.

The demodulation signal(s) (MIX) may be based on a periodic signal, e.g., a sine, a triangular function, a sawtooth function, a rectangular function, or the like.

It should be noted that, in the below figures description, the term “MIX” is used for the respective demodulation signal, but the present disclosure is not limited to such a specific nomenclature and it may be changed by the person skilled in the art according to the circumstances.

For example, if the demodulation signal (MIX) is a rectangular signal, a first part of the signal may have a first value (e.g. logic low) and a second part of the signal may have a second value (e.g. logic high). For example, the first part of the signal may be applied to TAP A to drain the electrons from TAP A and the second part of the signal may be applied to TAP B to drain the electrons from TAP B. For other functions or signals, the first and the second part may be defined accordingly or differently. For example, a sine (or cosine) may have a first part for values which are below its horizontal symmetric axis and a second part for values which are above (or equal to) the horizontal symmetric axis without limiting the present disclosure in that regard since the skilled person may adapt the first part and the second part according to the circumstances.

As indicated above, the first light pulse is detected with the first demodulation signal (e.g., MIX(0)).

Based on whether the first light pulse is detected in or with the first part of the first demodulation signal or the second part of the demodulation signal, the detection of a second light pulse with a second demodulation signal, after detection of the first light pulse, may be adapted such that the detection window for the detection of the second light pulse is shorter than the detection window for the detection of the first light pulse.

For example, in case the first demodulation signal is a rectangular signal and the first light pulse is detected in the logic zero part of the rectangular signal, the second demodulation signal may be adapted, such that a second light pulse may be detected by the second demodulation signal by not falling in the logic zero part of the rectangular signal of the second demodulation signal.

Furthermore, the second demodulation signal may be a signal in which the light pulse may be detected more exactly. For example, the second demodulation signal may have a higher (e.g. double) frequency than the first demodulation signal and one period of the second demodulation signal may thus correspond to half a period of the first demodulation signal. Hence, one period of the second demodulation signal can be timed to be parallel to the part of the first demodulation signal in which the light pulse was detected.

Hence, in some embodiments, the second demodulation signal may be centered around the light pulse.

In some embodiments, although the second demodulation signal may have a shorter period than the first demodulation signal, a frame length may remain the same (or may be adapted accordingly, if dynamic frame lengths are envisaged).

It should be noted that a light pulse may be repeated for a predetermined amount of periods (e.g., fifteen, twenty, hundred periods, or the like) and the demodulation signal (MIX) may be repeated for the same amount of periods or a different amount

It should be noted that light pulses or modulated light may be emitted after one another and thus, the first and the second demodulation signals may be applied after one another. Thus, “parallel” may not refer to the signals being applied at the same real time, but such that they correspond to each other in an internal timing, as will be discussed further below with respect to the figures. Hence, the selection signal may include at least one of a phase, a frequency, a timing, and a number of detection time intervals (e.g. frames), without limiting the present disclosure in that regard and other selection signals may be envisaged, for example when the demodulation signal (MIX) is aperiodic or has multiple frequencies or periods.

Accordingly, in some embodiments, the second demodulation signal differs from the first demodulation signal in a phase shift.

Thus, the second demodulation signal may be based on the first demodulation signal. For example, a signal shape may be the same or similar (e.g. both are rectangular signals), but a timing and a frequency may be different, as indicated above.

In some embodiments, the imaging element includes a photo-detection element with a structure including an overflow gate (OFG). The overflow gate, when active, may be configured to dim all photo generated electrons from the photo-detection element such that no signal from the light pulses is detected when the demodulation signal (MIX) is applied. In an example, when the overflow gate is active, the voltage applied to the overflow gate (DIM) is set higher than the voltage of the demodulation signal (MIX) that is applied to the Tap A and/or Tap B. In another example, the overflow gate is activated by connecting it to the ground. The selection signal may be configured to disable light detection during a determined time window that corresponds to a part of a previously applied demodulation signal.

In some embodiments, the first selection signal is set in such a way that the second light pulse is detected in a predetermined part of the second demodulation signal. For example, the predetermined part of the second demodulation signal may be a time window of the first demodulation signal during which light pulse detection was activated. The time window may match a time window during which the first light pulse was detected.

When the second light pulse is detected in the predetermined part of the second demodulation signal, the second light pulse may be detected with a lower background noise due to a lower integration time. The predetermined part is roughly predicted, based on the first demodulation signal, when the light pulse has arrived. This may also be possible when a further demodulation signal for a further light pulse is used before the first demodulation signal for the first light pulse, such that a tendency can be determined when the light pulses arrive.

In some embodiments, the second demodulation signal has a double frequency than the first demodulation signal, as discussed herein.

In some embodiments, the time-of-flight demodulation circuitry is further configured to: detect, after detecting the first and the second light pulses, a third light pulse with a third demodulation signal, as discussed herein.

In some embodiments, the first, second, and third demodulation signals are based on a Gray code, such that above discussed tendency can be determined and such that the second demodulation signal can be adapted accordingly.

In some embodiments, the first and the second demodulation signals are rectangular signals, as discussed herein.

In some embodiments, the first and the second light pulses are detected by folding a respective light pulse signal, which is generated in response of the respective light pulse being incident on an imaging element, with the respective demodulation signal.

In some embodiments, the light pulse is longer than a half period of the respective demodulation signal period. This allows to process the demodulated signal from tap A and tap B in a statistical mode as it is known by the skilled person.

In some embodiments, the light pulse is emitted with a full filed illuminator. In some embodiments, the light pulse is emitted with a spot patterned illuminator. Hence, the totally processed signal may correspond to a superposition of the respective light pulse signal (a signal which is generated on the imaging element when the light pulse is incident on the imaging element) and the respective demodulation signal.

In some embodiments, for a pulsed measurement with a demodulation signal, several integrations of the emitted light pulses are carried out with a random repetition rate. Such embodiment may allow to have light pulses with higher peak power and thus improve the SNR of the pulsed measurement. Such embodiment is also beneficial for range clipping and multicamera operation.

In some embodiments, the circuitry is further configured to: apply the second mixing signal and the second mixing signal during the second determination.

In some embodiments, the selection signal is configured to selectively disable the demodulated light signal integration with the second mixing signal.

In some embodiments, the circuitry is further configured to: output a digital signal for each determination being indicative of a pulse location.

In some embodiments, the circuitry is further configured to: carry out an analog indirect time-of-flight pulsed measurement at a maximum measurement frequency, thereby matching a pulse length to half a period of the maximum measurement frequency.

In some embodiments, the circuitry is further configured to: carry out the first and the second determination when a signal loss is determined.

In some embodiments, the signal loss is detected by comparing a norm of multiple time-of-flight measurements.

In some embodiments, the signal loss is detected by checking continuity of depth values over multiple measurements.

In some embodiments, the circuitry is further configured to: adjust a zoom window at a highest frequency based on a measured location of a light pulse, the adjustment including moving forward the zoom window, if the pulse lies within a second half of the zoom window, and moving backward if the pulse lies within a first half of the zoom window.

In some embodiments, the selection signal is used for disabling detection of light pulses with the mixing signals in a first part of the respective mixing signal and to allow detection of light pulses with mixing signals in a second part of the respective mixing signal.

In some embodiments, the second mixing signal has a frequency higher than or equal to the selection signal.

In some embodiments, the selection signal is set in such a way that a light pulse is detected in a predetermined part of the second mixing signal.

In some embodiments, the first mixing signal includes a first part and a second part; and wherein the selection signal is set based on whether the light pulse is mainly detected in the first part or in the second part of the first mixing signal.

In some embodiments, the second demodulation signal has a double frequency than the first demodulation signal.

In some embodiments, the circuitry is further configured to: use a second selection signal for disabling detection of light, the second selection signal being set based on the second integrated demodulated signal; and carry out a third determination including: integrating the light signal demodulated with a third mixing signal into a third integrated demodulated signal based on the second selection signal.

In some embodiments, the first, second, and third mixing signals are based on a Gray code.

In some embodiments, the mixing signals and selection signals are rectangular signals.

In some embodiments, the first and the second light pulses are detected by folding the light signal with the respective mixing signal. Some embodiments pertain to a time-of-flight demodulation method including: carrying out a first determination and a second determination, the first determination including: integrating a light signal demodulated with a first mixing signal into a first integrated demodulated signal; and setting a selection signal for disabling detection of light, the selection signal being set based on the first integrated demodulated signal for integrating, in the second determination, the light signal demodulated with a second mixing signal into a second integrated demodulated signal for a shorter time period than in the first determination; the second determination including: integrating the light signal demodulated with the second mixing signal into the second integrated demodulated signal based on the selection signal, as discussed herein.

The method may be carried out with ToF demodulation circuitry according to the present disclosure. Moreover, all the functional configurations described with respect to the circuitry may be adapted to be carried out in the method accordingly.

In some embodiments, the first selection signal parameter includes a phase, a frequency, a timing, and a number of detection time intervals, as discussed herein. In some embodiments, the first selection signal and the second demodulation signal are applied simultaneously to the pixel such that the demodulation time period for detecting the second light pulse is shorter than with the first demodulation signal, as discussed herein. In some embodiments, the first selection signal is set in such a way that the second light pulse is detected in a predetermined part of the second demodulation signal by disabling the light detection by the second demodulation signal when activating the overflow gate of the pixel, as discussed herein. In some embodiments, the second demodulation signal has a double frequency than the first demodulation signal, as discussed herein. In some embodiments, the time-of-flight demodulation method further includes: detecting, before detecting the first and the second light pulses, a third light pulse with a third demodulation signal, as discussed herein. In some embodiments, the first, second, and third demodulation signals are based on a Gray code, as discussed herein. In some embodiments, the first and the demodulation signals are rectangular signals, as discussed herein. In some embodiments, the first and the second light pulses are detected by folding a respective light pulse signal, which is generated in response of the respective light pulse being incident on an imaging element, with the respective demodulation signal, as discussed herein. In some embodiments, the method further includes: applying the second mixing signal and the second mixing signal during the second determination, as discussed herein. In some embodiments, the selection signal is configured to selectively disable the demodulated light signal integration with the second mixing signal, as discussed herein. In some embodiments, the method further includes: outputting a digital signal for each determination being indicative of a pulse location, as discussed herein. In some embodiments, the method further includes carrying out an analog indirect time-of-flight pulsed measurement at a maximum measurement frequency, thereby matching a pulse length to half a period of the maximum measurement frequency, as discussed herein. In some embodiments, the method further includes: carrying out the first and the second determination when a signal loss is determined, as discussed herein. In some embodiments, the signal loss is detected by comparing a norm of multiple time-of-flight measurements, as discussed herein. In some embodiments, the signal loss is detected by checking continuity of depth values over multiple measurements, as discussed herein. In some embodiments, the method further includes adjusting a zoom window at a highest frequency based on a measured location of a light pulse, the adjustment including moving forward the zoom window, if the pulse lies within a second half of the zoom window, and moving backward if the pulse lies within a first half of the zoom window, as discussed herein. In some embodiments, the selection signal is used for disabling detection of light pulses with the mixing signals in a first part of the respective mixing signal and to allow detection of light pulses with mixing signals in a second part of the respective mixing signal, as discussed herein. In some embodiments, the method further includes the second mixing signal has a frequency higher than or equal to the selection signal, as discussed herein. In some embodiments, the selection signal is set in such a way that a light pulse is detected in a predetermined part of the second mixing signal, as discussed herein. In some embodiments, the first mixing signal includes a first part and a second part; and the selection signal is set based on whether the light pulse is mainly detected in the first part or in the second part of the first mixing signal, as discussed herein. In some embodiments, the second demodulation signal has a double frequency than the first demodulation signal, as discussed herein. In some embodiments, the method further includes: using a second selection signal for disabling detection of light, the second selection signal being set based on the second integrated demodulated signal; and carrying out a third determination including: integrating the light signal demodulated with a third mixing signal into a third integrated demodulated signal based on the second selection signal, as discussed herein. In some embodiments, the first, second, and third mixing signals are based on a Gray code, as discussed herein. In some embodiments, the mixing signals and selection signals are rectangular signals, the first and the second light pulses are detected by folding the light signal with the respective mixing signal, as discussed herein.

In some embodiments, pixel binning is applied to the first step. In some embodiments, pixel binning is applied to the second step. In some embodiment, pixel binning is applied to the third step. In some embodiment, 2³ pixel binning is applied to the first step, 2² pixel binning is applied to the second step, 2¹ pixel binning is applied to the third step, and 2⁰ pixel binning is applied to the fourth step. Such embodiments may allow to keep a constant integration time for a similar expected SNR over the entire method described herein. The number of steps of the described embodiment could be varied to only 2 and up to more than 4.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Some embodiments pertain to a time-of-flight device including: a light source; at least one light detection element configured to generate an electric signal in response to a detection of light being emitted from the light source and reflected at a scene, the light detection element including an overflow gate configured to selectively disable the detection of light by applying a selection signal; and time-of-flight demodulation circuitry configured to: carry out a first determination and a second determination, the first determination including: integrating the light signal demodulated with a first mixing signal into a first integrated demodulated signal; and set the selection signal for disabling detection of light, the selection signal being set based on the first integrated demodulated signal for integrating, in the second determination, the light signal demodulated with a second mixing signal into a second integrated demodulated signal for a shorter time period than in the first determination; the second determination including: integrating the light signal demodulated with the second mixing signal into the second integrated demodulated signal based on the selection signal, as discussed herein.

Returning to FIG. 1, there is depicted a timing diagram 1 according to the present disclosure, wherein different demodulation signals are applied according to a Gray code.

The horizontal axis (abscissa) of the timing diagram 1 is indicative of a time and the vertical axis (ordinate) is indicative of a signal strength of the respective signals depicted below each other.

On the top of the timing diagram 1, an emitted light signal diagram 2 is depicted including an output power Pₒᵤₜ of a light pulse 3.

Below the emitted light signal diagram 2, a received light signal diagram 4 is shown including a received light pulse 5, wherein a time span between a center of the emitted light pulse 3 and the received light pulse 5 is defined as the time of flight.

An applied first demodulation (mixing) signal MIX(0) is depicted below the received light signal diagram 4. The applied first demodulation signal MIX(0) lies between the relative values TAP A and TAP B (or MIX A and MIX B as referred to in FIG. 1) representing a logical low and logical high, respectively. Moreover, the applied first demodulation signal MIX(0) is a rectangular signal which has a first part in the first half period having the relative value TAP A and a second part in the second half period having the relative value TAP B. Moreover, the applied first demodulation signal MIX(0) is applied such as to cover the ToF range of the ToF system including the ToF demodulation circuitry of the invention.

When the first demodulation signal MIX(0) is applied, the light signal is collected by TAP A when it is at the relative value TAP A and the light signal is collected by tap B when it is at the relative value TAP B. During step 1 (wherein according to the present disclosure, the steps do not necessarily represent a predetermined order), the first demodulation signal MIX(0) is applied to the TAPs A and B, and at the same time a first selection signal DIM(0) is applied to the overflow gate (OFG). The first selection signal DIM(0) (or only called selection signal herein) is configured to disable light detection by the TAPs A and B when it is at the relative value dim and is configured to not interact with TAPs A and B for light detection when it is at the relative value 0.

As the outcome of step 1, it is determined that the light pulse lies in the first part of first demodulation signal MIX(0) because the received light pulse 5 has been detected by TAP A.

In some embodiments, the first selection signal DIM(0) is applied to the overflow gate but without disabling the light detection from the TAPs during step 1. In some embodiments, no selection signal is applied to the overflow gate during step 1.

Hence, a (second) selection signal DIM(1) can be determined as the outcome of step 1 based on whether the first light pulse is detected in the first part and/or in the second part of the first demodulation signal MIX(0).

In step 2, the second demodulation signal MIX(1) is generated which corresponds to the first applied demodulation signal MIX(0) but is ninety degrees phase-shifted. In step 2, the second demodulation signal MIX(1) and the second selection signal DIM(1) are applied simultaneously such that the ToF demodulation circuitry is configured to only detect light signal with MIX(1) from TAP A and B during a time window determined by DIM(1). Hence the second selection signal DIM(1) is configured to dim all photo generated electron when its relative value is at dim by interfering with TAP A and B. When DIM(1) is at relative value 0, the OFG does not to interfere with TAP A and B. During step 2, DIM(1) and MIX(1) are set such that MIX(1) switches from TAP A to TAP B during the acquisition of the light signal by the taps. The acquisition of the light signal by the taps is determined by the relative value of selection signal.

As the outcome of step 2, it is determined that the light pulse lies in the second part of second demodulation signal MIX(1) because the received light pulse 5 has been detected by TAP B.

Hence, a third selection signal DIM(2) can be determined as the outcome of step 1 and as explained herewith and also as an outcome of step 2 based on whether the first light pulse is detected in the first part and/or in the second part of the second demodulation signal MIX(1). In some embodiments, the (third) selection signal DIM(2) is a determined based on the outcome of steps 1 and 2. In some embodiments, the third selection signal DIM(2) is a combination of the outcome of step 1 and of the outcome of step 2.

In step 3, the third demodulation signal MIX(2) is generated with a frequency that is doubled compared to the first MIX(0) and second MIX(1) applied demodulation signals. In step 3, the third demodulation signal MIX(2) and the third selection signal DIM(2) are applied simultaneously such that the ToF demodulation circuitry is configured to only detect light signal with MIX(2) from TAP A and B during a time window determined by DIM(2). Hence the third selection signal DIM(2) is configured to dim all photo generated electron when its relative value is at dim by interfering with TAP A and B. When DIM(2) is at relative value 0, the OFG does not to interfere with TAP A and B. During step 3, DIM(2) and MIX(2) are set such that MIX(2) switches from TAP A to TAP B during the acquisition of the light signal by the taps. The acquisition of the light signal with MIX(2) by the taps is determined by the relative value of selection signal DIM(2).

As the outcome of step 3, it is determined that the light pulse lies in the first part of third demodulation signal MIX(2) because the received light pulse 5 has been detected by TAP B.

Hence, a fourth selection signal DIM(3) can be determined as the outcome of step 2 as explained herewith (with is also an outcome of step 1) and also as an outcome of step 3 based on whether the first light pulse is detected in the first part and/or in the second part of the third demodulation signal MIX(2). In some embodiments, a fourth selection signal DIM(3) is determined based on the outcome of step 1, step 2, and step 3. In some embodiment, the fourth selection signal DIM(3) is a combination of the outcome of step 1, of the outcome of step 2, and of the outcome of step 3. Generally, the present disclosure is not limited to any number of mixing/demodulation signals and/or selection signals.

In step 4, the fourth demodulation signal MIX(3) is generated with a frequency that is doubled compared to the third applied demodulation signals MIX(2). In step 4, the fourth demodulation signal MIX(3) and the fourth selection signal DIM(3) are applied simultaneously such that the ToF demodulation circuitry is configured to only detect light signal with MIX(3) from TAP A and B during a time window determined by DIM(3). Hence the fourth selection signal DIM(3) is configured to dim all photo generated electron when its relative value is at dim by interfering with TAP A and B. When DIM(3) is at relative value 0, the OFG does not to interfere with TAP A and B. During step 4, DIM(3) and MIX(3) are set such that MIX(3) switches from TAP A to TAP B during the acquisition of the light signal by the taps. The acquisition of the light signal with MIX(3) by the taps is determined by the relative value of selection signal DIM(3).

As the outcome of step 4, the depth can be determined by known methods using the signal from tap A and tap B. Moreover, the present disclosure is not limited to any number of mixing/demodulation signals and/or selection signals, such that four or more signals may be envisaged.

In a typical embodiment the pulse length is equal to half of the period of the demodulation signal of step 4 to allow calculating the depth with the traditional iTOF equations, e.g. D=Dₛₜₑₚ₁₋₃+Dₛₜₑₚ₄ & Dₛₜₑₚ₄=pulse range*(TapB−TapA)/(abs (TapB)+abs (TapA)) & Dₛₜₑₚ₁₋₃=range until Dim(2) goes down.

However, it should be recognized that it may be sufficient to only have a first and a second demodulation signal with a first and a second selection signal in order to carry out the present disclosure and to benefit from the technical effect of the invention, as discussed herein.

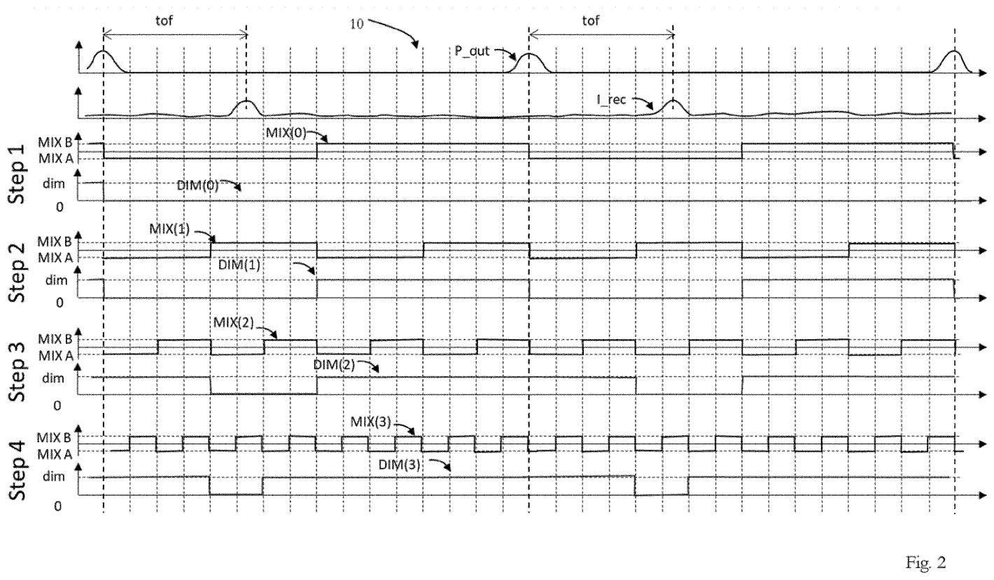

FIG. 2 depicts a further embodiment of a timing diagram 10.

The timing diagram 10 is different from the timing diagram 1 in that other applied demodulation signals are generated, such that a digital (binary) demodulation signal MIX(0) to MIX(3) sequence is applied instead of a Gray coded sequence as in FIG. 1. However, the principles described with respect to FIG. 1 apply for setting of the selection signal DIM(0) to DIM(3) accordingly.

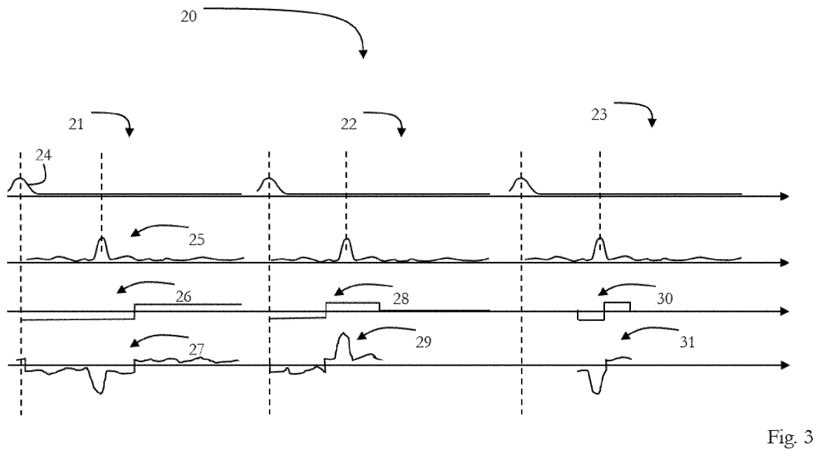

FIG. 3 depicts a further timing diagram 20 according to the present disclosure.

The timing diagram 20 includes three consecutive detections 21, 22, and 23 corresponding to step 1, step 2 and step 3 as explained in FIG. 1 and FIG. 2. In some embodiments, for each of the three consecutive detections 21, 22, and 23, several light pulses are emitted and detected.

For each detection (e.g. time interval or frame), several light pulses 24 are emitted and light detection signals 25 including reflected light pulses are generated. The light pulses 24 and 25 are depicted as power plotted versus time.

However, in the detection 21, a first demodulation signal 26 (or demodulation voltage) is applied which is folded or superposed with the detected light pulse, such that a readout current 27 is generated.

In the second detection 22, a second demodulation signal 28 is applied which has a double frequency (and thus a half detection time interval) than the first demodulation signal 26 at a time after emission of the light pulse 24 (in the second detection 22) which corresponds to the time of the first part of the first demodulation signal 26 (in the first detection 21).

The second demodulation signal 28 is folded or superposed with the light detection signal 25, such that a readout current 29 is generated, which is measured on a shorter time range than the readout current 27, but the peak which is generated based on the light pulse is still included. Hence, in total the readout current 29 will generate less noise than the readout current 27 when it is evaluated, i.e. when a distance is determined.

In the detection 23, a third demodulation signal 30 is applied in a similar way as described above. Since the peak laid in the second part (logic high) of the second demodulation signal 28 (which can be determined since the peak has a positive value), the third demodulation signal 30 is only applied at a time corresponding to a time of the second part of the second demodulation signal 28 (hence, a detection time interval is halved). Moreover, the third demodulation signal 30 has a double frequency with respect to the second demodulation signal 28.

A resulting readout current 31 is measured on a still shorter time range than the readout current 29, but still includes the peak (in form of a negative peak, or dip).

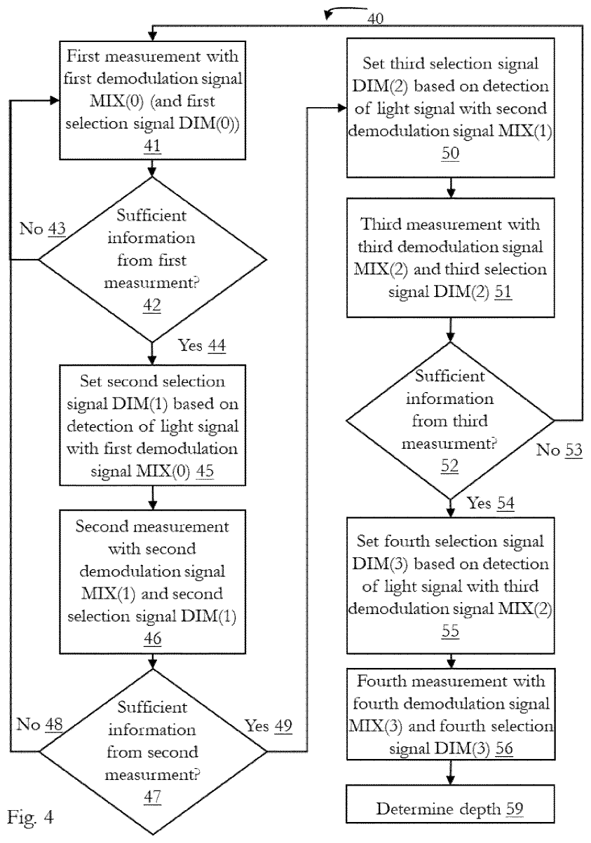

FIG. 4 depicts a time-of-flight demodulation method 40 according to the present disclosure.

At 41, a first ToF pulsed measurement is carried out with a first demodulation signal (which is initiated with a first pulsed light signal). In some embodiments, the first demodulation signal lies between a logical low (minus one) and a logical high (plus one). In some embodiments, the first demodulation signal MIX(0) has a period T₁. In some embodiments, the first ToF pulsed measurement is an iToF pulsed measurement.

In some embodiments, the first measurement is carried out with a first selection signal DIM(0). For example, the first selection signal DIM(0) is set not to disable light detection with the first demodulation signal.

At 42, it is decided whether sufficient information from first measurement has been determined. In some embodiments, at 42, sufficient information from first measurement is determined based on the detection of the first light pulse. In some embodiments, at 42, sufficient information from first measurement can be decided when first measurement output has too low SNR for depth calculation, but part of the first measurement output is high enough for estimating in which part of the first modulation signal the first light pulse is detected. In some embodiments, at 42, the first measurement output can feature no light pulse detected, which then indicates that the light pulse could be detected in the time window of the demodulation signal corresponding to long distances. Low SNR could also be detected by requiring multiple, e.g. 2 or 3, consecutive measurements to indicate the same result. In some embodiments, the first measurement signal output is filtered by software, e.g. applying a known filter to the detected signal.

If not, 43, the first iToF pulsed measurement is carried out again.

If yes, 44, at 45, a second selection signal DIM(1) is set based on detection of light signal with the first demodulation signal MIX(0). In some embodiments, it is determined how the first light pulse has been detected between tap A (logical low) and tap B (logical high) of the first demodulation signal MIX(0). In some embodiments, the second selection signal DIM(1) is then set based on whether the first light pulse has mainly been detected with tap A or tap B. In some embodiments, at 45, a half period of the first demodulation signal MIX(0) is selected based on the most promising half period to contain the reflected pulsed light signal. For example, the most promising half period is determined by software, e.g. applying a known filter to the detected signal, or the most promising half period is determined by averaging out the measurement signal outputs (one for each half period), e.g. on capacitors in a circuit, and then comparing the resulting averaged voltage with a comparator.

At 46, a second measurement with a second pulsed light signal is carried out with a second demodulation signal MIX(1) and a second selection signal DIM(1). In some embodiments, the second demodulation signal MIX(1) lies between a logical low and a logical high, as the first demodulation signal MIX(0). In some embodiment, the second demodulation signal MIX(1) has a period T₂. For example T₂=T₁/2. In another example T₂-T₁ with T₂ being phase shifter by + or −90° compared to T₁. In some embodiments, the second measurement is an iToF pulsed measurement.

At 47, it is decided whether sufficient information from the second measurement has been determined. In some embodiments, at 47, sufficient information from the second measurement is determined based on the detection of the second light pulse. In some embodiments, at 47, sufficient information from the second measurement is decided when a second measurement output has too low SNR for depth calculation, but part of the second measurement output is high enough for estimating in which part of the second modulation signal the second light pulse is detected. At 47, the second measurement output can feature no light pulse detected, which then indicates that a subsequent light pulse could be detected in the time window of the demodulation signal corresponding to long distances. In some embodiments, the second measurement signal output is filtered out by software, e.g., by applying a known filter to the detected signal.

If not, 48, the first measurement is carried out again, without limiting the present disclosure in that regard since the second measurement may be carried out again, in some embodiments.

If yes, 49, at 50, a third selection signal DIM(2) is set based on detection of light signal with second demodulation signal MIX(1). In some embodiments, it is determined how the second light pulse has been detected between the tap A (logical low) and the tap B (logical high) of the second demodulation signal MIX(1). In some embodiments, the second selection signal DIM(1) is then set based on whether the second light pulse has mainly been detected with tap A or tap B. At 50, a half period of the second demodulation signal MIX(1) is selected based on the most promising half period to contain the reflected pulsed light signal. For example, the most promising half period is determined by software, e.g. applying a known filter to the detected signal.

At 51, a third measurement with a third pulsed light signal is carried out with a third demodulation signal MIX(2) and a third selection signal DIM(2). In some embodiments, the third demodulation signal MIX(2) lies between a logical low and a logical high, as the first MIX(0) and the second MIX(1) demodulation signals. In some embodiments, the third demodulation signal MIX(2) has a period T₃, for example T₃=T₂/2. In another example T₃=T₂ with T₃ being phase shifted by + or −90° compared to T₂. In some embodiments, the third measurement is an iToF pulsed measurement.

At 52, it is decided whether sufficient information from third measurement has been determined.

The principles described with respect to step 42 and 47 apply accordingly to step 52.

If not, 53, the pulsed measurement is carried out again, without limiting the present disclosure in that regard since the second or third measurement may be carried out again, in some embodiments.

If yes, 54, at 55, a fourth selection signal DIM(3) is set based on detection of light signal with third demodulation signal MIX(2). The embodiments of steps 45 and 50 may apply to current step 55 accordingly.

At 56, a fourth measurement with a fourth pulsed light signal is carried out with a fourth demodulation signal MIX(3) and a fourth selection signal DIM(3). In some embodiments, the fourth demodulation signal MIX(3) lies between a logical low and a logical high, as the first MIX(0), the second MIX(1), and the third MIX(2) demodulation signals. In some embodiments, the fourth demodulation signal MIX(3) has a period T₄. For example T₄=T₃/2. In another example T₄=T₃ with T₄ being phase shifter by + or −90° compared to T₃. In some embodiments, the fourth measurement is an iToF pulsed measurement.

At 59, a time-of-flight of the reflected fourth light pulse is determined (calculated) based on the recorded fourth measurement. Then a depth based on the time-of-flight is calculated. In some embodiments, the current during the fourth demodulation signal MIX(3) is recorded from Tap A and Tap B and a time-of-flight is determined as it is generally known for a 2-tap iToF measurement.

In some embodiments, when an iToF pulsed measurement with a pulsed light signal and a demodulation signal triggered by the selection signal determined from the previous pulsed measurement is carried out, the delay can be obtained using the integrated current given by tap A 63 and tap B 64 using MIX(3). The integrated current is obtained by applying a subsequent demodulation signal and by activating the overflow gate to dim all generated photoelectrons as dictated by the DIM(3) signal.

If the pulse length is chosen in such a way that the window duration of the last step is corresponds to this pulse length. Final precision and analog value for the TOF can be acquired by the standard pulsed TOF equations. E.g. delay˜(pulse length+pulse length×(tap A−tap B/(tapA−amb)+(tapB−amb)))). (amb stands for an ambient light measurement, which can be obtained in a subsequent measurement as known by a person skilled in the art).

FIG. 4 describes four steps with four demodulation signals. The process described by FIG. 4 can easily be extended to more steps or even shortened to less steps.

In some embodiments, the first, second, third, and fourth selection signals are also referred to, independently or globally, as zooming signal.

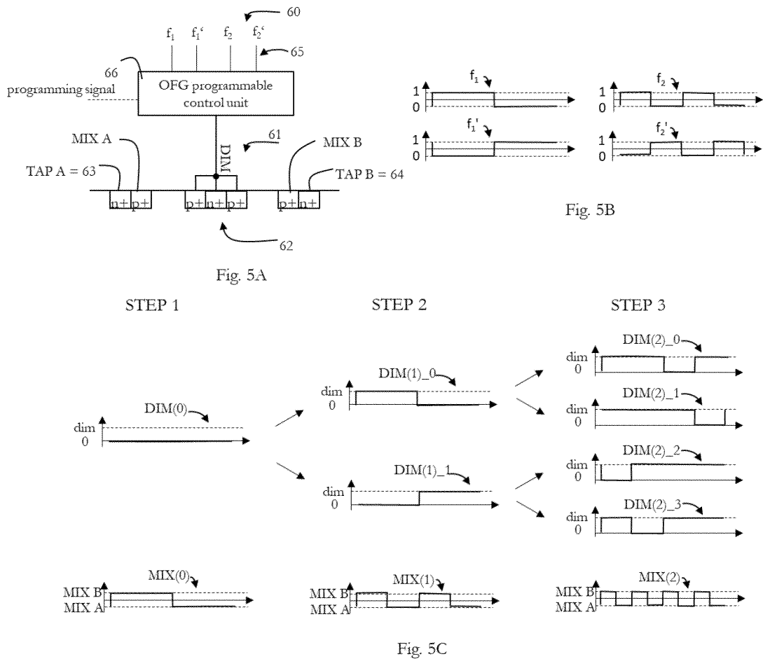

FIG. 5A depicts time-of-flight demodulation circuitry 60 according to the present disclosure being connected to an imaging element 61 and configured to read out charges generated in the imaging in response to light being incident on the imaging element.

The ToF demodulation circuitry 60 is connected to an overflow gate 62 of the imaging element 61 which constitutes a dump (trash) node of the imaging element 61. The imaging element further includes two taps 63 (tap A) and 64 (tap B), as it is generally known. The overflow gate 62 is configured to dim most of the photo generated electrons in the imaging element such that none of them can be collected by the two taps, even when a demodulation signal is applied to the two taps.

The ToF demodulation circuitry 60 includes a plurality of reference signal lines 65 (f₁, f₁′, f₂, f₂′). The ToF demodulation circuitry 60 further includes an OFG programmable control unit 66 which can, based on the programming signal, generate a selection signal DIM by combining any of the reference signal (f₁, f₁′, f₂, f₂′) from the reference signal lines 65. As it is generally known, the imaging element includes pixel readout lines connected to the two taps 63 (tap A) and 64 (tap B). The demodulation signal MIX is applied to the two taps 63, 64, by the pixel readout line which is different from the line connecting the OFG 62.

Hence, the overflow gate 62 and the taps 63, 64 can be biased by the selection signal DIM and by the demodulation signals MIX respectively synchronously.

If the overflow gate 62 is not biased by the selection signal DIM, the demodulation signal MIX does not collect charges from the photosensitive material (not shown) of the imaging element 61 and the pixel can be driven as a standard two taps CAPD pixel, for example.

If the overflow gate 62 is biased by the selection signal DIM, it collects (almost all) charges from the photosensitive material and the signal on the two taps is null and the overflow gate can be driven, for example, according to the timing diagrams as discussed herein (when the selection signal DIM is at dim, the overflow gate 62 is biased and when at 0, it is not biased).

In some embodiments, MIX(0, 1, 2, 3)=MIX B-MIX A.

FIG. 5B depicts the reference signals f₁, f₁′, f₂, f₂′ that are connected to the OFG programmable unit 66 and which oscillate between 0 and 1. Reference signal f₁′ is the inverse of reference signal f₁. Reference signal f₂′ is the inverse of reference signal f₂. Reference signals can have other frequency and phase that the ones depicted in FIG. 5B.

FIG. 5C depicts selection signals DIM and demodulation signals MIX for step 1, 2, and 3.

At step 1, first selection signal DIM(0) is set at 0 and first demodulation signal MIX(0) oscillates between TAP A and TAP B.

At step 2, the second selection signal DIM(1) is selected between DIM(1)_0 for which the OFG is activated at the beginning of the period or DIM(1)_1 for which the OFG is activated at the end of the period. The second demodulation voltage MIX(1) oscillates between TAP A and TAP B with a higher frequency that first demodulation voltage MIX(0).

At step 3, the third selection signal DIM(2) is selected between DIM(2)_0, DIM(2)_1, DIM(2)_2, DIM(2)_3 for which each is able to activate the OFG 62 during three quarter of the measurement window (the readout from the demodulation signal is then one quarter of the measurement window). The third demodulation voltage MIX(2) oscillates between TAP A and TAP B with a higher frequency that first MIX(0) or second MIX(1) demodulation voltage.

In some embodiments, the ToF demodulation circuitry 60 is connected to a source follower in order that the reference signals f₁, f₁′, f₂, f₂′, f₃, f₃′, and so on, with the highest voltage are driving the overflow gate 62 without interference from the reference signal with lower voltage.

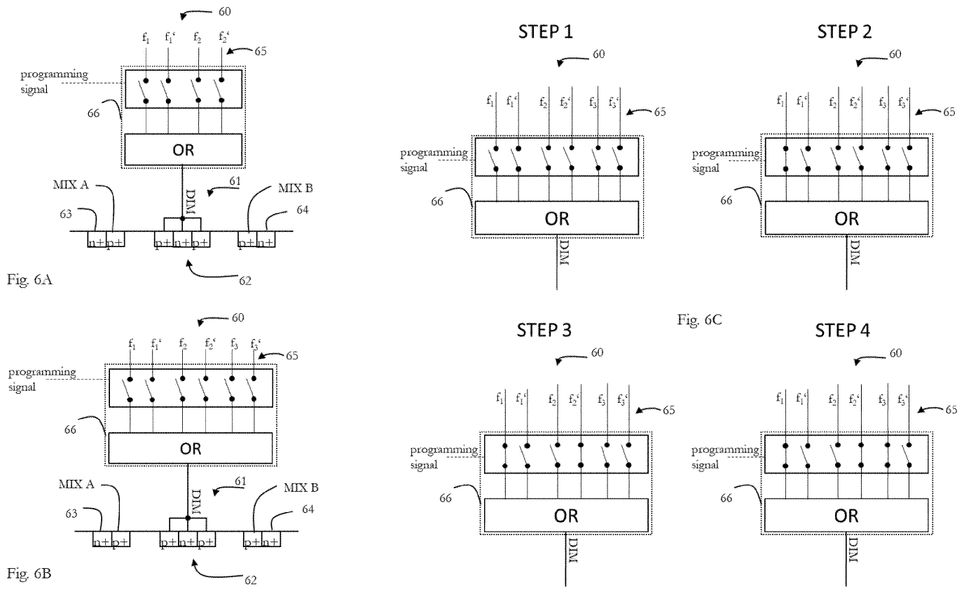

FIG. 6 depicts a more specific representation of the more general concept depicted in FIG. 5A where the OFG programmable control unit 66 includes programmable switches for each reference signal input, each output of the switch is connected to an OR unit than can combine the output of the switch in a selection signal DIM. It is to be noted that the programmable switches as show in FIG. 6 are for illustrative purpose only and are not meant to be implemented as such in a demodulation circuitry.

FIG. 6B depicts that the OFG programmable control unit 66 includes extra reference signal inputs f₃ and f₃′. The embodiment of FIG. 6B allows to set a third selection signal having a different frequency than the second and the first selection signal.

FIG. 6C depicts the programming of the OFG programmable control unit 66 corresponding to the steps 1, 2, 3 and 4 of the steps described in FIG. 2 respectively.

In some embodiments, when the location of the pulse is nearing the end of the measurement window, the selection signals can be shifted by half a period of the last selection signal applied to carry out the depth measurement together with the last demodulation signal. For example, this can be achieved by aligning the selection signals of DIM(0), DIM(1), and DIM(2) with the rising edge of DIM(3) applied to carry out the depth measurement together with MIX(3) instead of the falling edge, using the needed logic. The needed logic is known from the skilled person.

In some embodiments, a loss of lock-in can be detected when a pixel has several (e.g. 10) consecutive random shifts, meaning that the reflected pulse signal has been lost (very likely because it is not in the time window defined by the last selection signal applied.

In some embodiments, a delay may correspond to a shift of selection signals DIM(0) to DIM(2) forward by half a period of DIM(3), and reprogramming the fourth selection signal DIM(3) by reprogramming the OFG programmable control unit such that f₃ is applied instead of f₃′ thereby delaying the focus area by half a period of f₃. In this case, the total delay becomes again half a period of the fourth demodulation signal MIX(3).

In some embodiments, shifting forward could be achieved by a similar reprogramming than the one explained for the delaying mechanism.

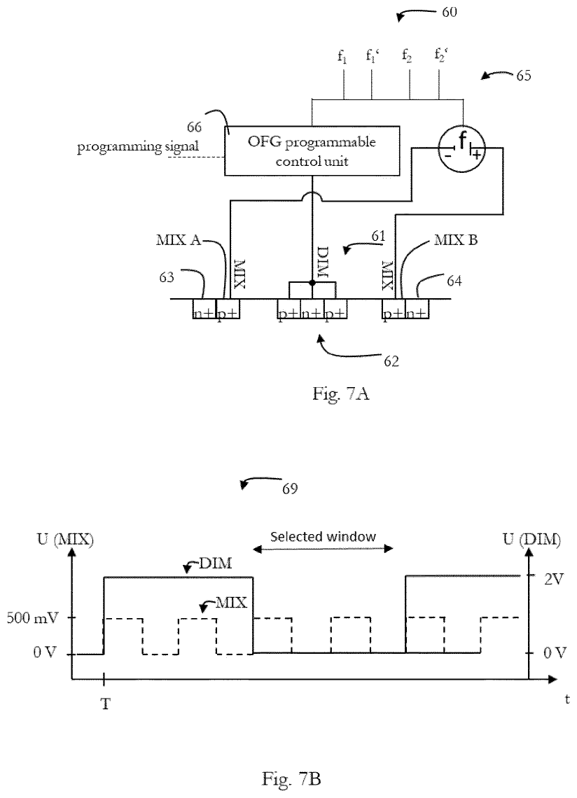

In some embodiments, a biasing voltage is roughly two volts and the (maximum) voltage of the demodulation signals is roughly five-hundred millivolts, as shown in FIGS. 7A and 7B. FIG. 7B shows a timing diagram 69 for the overflow gate 62 of a device 60 depicted in FIG. 7A (corresponding to the device depicted in FIG. 5A, but additionally including a frequency generator). On the timing diagram 69, voltages U (DIM) and U (MIX) are plotted versus a time t. At a time T, the overflow gate 62 (OFG) is biased with two volts with the selection signal DIM and the demodulation signal MIX is thus applied to the taps A and B. The demodulation signal MIX is biased with a 500 mV bias.

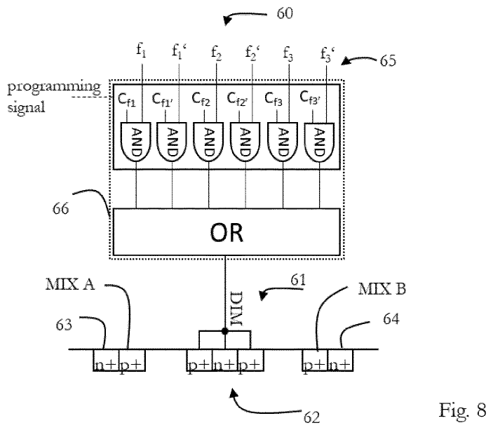

FIG. 8 depicts another embodiment of the ToF pixel according to FIG. 6A. The difference between FIG. 6A and FIG. 8 is that the OFG programmable control unit 66—instead of switches—includes one AND gate for each of the reference signal f₁, f₁′, f₂, f₂′, f₃, f₃′. Each AND gate is then connected to both a reference signal and a control signal C_{f1}, C_{f1}′, C_{f2}, C_{f2}′, C_{f3}, C_{f3}′.

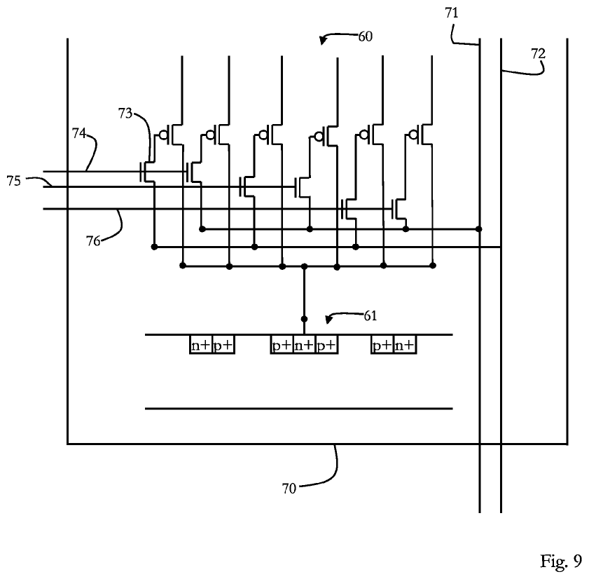

FIG. 9 depicts a ToF pixel 70 according to the present disclosure. The ToF pixel 70 includes the ToF demodulation circuitry 60 and the imaging element 61, as discussed under reference of FIG. 5, for example, such that a repetitive description thereof is omitted.

Furthermore, the ToF pixel 70 includes column signal lines 71 and 72, such that the ToF pixel 70 can be implemented on an image sensor or pixel array.

Moreover, to each demodulation signal line 65, a transistor 73 is provided, which is connected to a gate of the switch 66, wherein the transistors 73 for the signal lines f₁, f₂, and f₃ are further connected to the column signal line 72, and the transistors 73 for the signal lines f₁′, f₂′, and f₃′ are connected to the column signal line 71.

In some embodiments, the ToF pixel includes reference signal lines that provide to the demodulation circuitry with the reference signals f₁, f₁′, f₂, f₂′ (or f₁, f₂, f₃, f₄).

A gate of the transistors 73 for the signal lines f₁ and f₁′ is further connected to a first program line 74. A gate of the transistors 73 for the signal lines f₂ and f₂′ is further connected to a second program line 75. A gate of the transistors 73 for the signal lines f₃ and f₃′ is further connected to a third program line 76. The program lines 74 to 76 constitute row connections for a pixel array and are connected to a control (not shown) and are used for reading out by applying a signal to the gates.

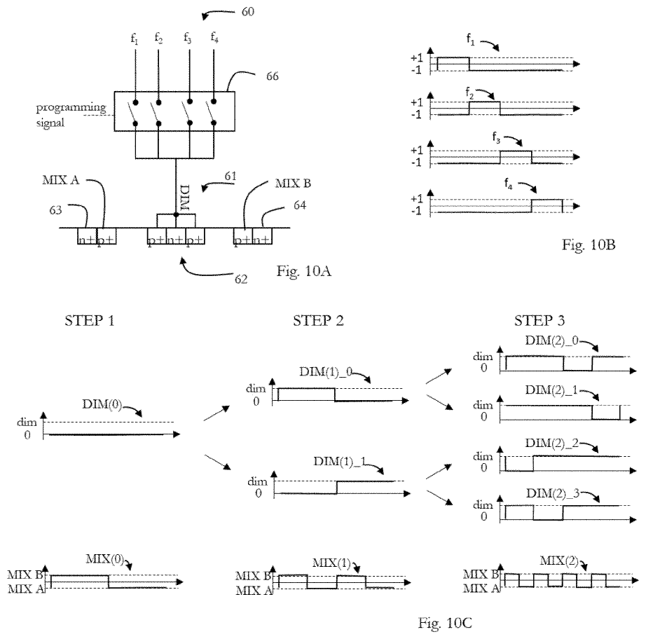

FIG. 10 depicts an alternative embodiment of the concepts shown in FIGS. 5, 6, 8, and 9. The difference between FIG. 10A and FIG. 6A is regarding the reference signals and the OFG programmable control unit 66. In FIG. 10A, the reference signals are labelled f₁, f₂, f₃, and f₄. One period of each of the reference signals f₁, f₂, f₃, and f₄ is depicted on FIG. 10B.

The embodiment depicted in FIG. 10 is designed for having three steps with two zooming steps as it is depicted in FIG. 10C.

FIG. 10C depicts selection signals DIM and demodulation signals MIX for steps 1, 2, and 3.

At step 1, first selection signal DIM(0) is set at 0 and first demodulation signal MIX(0) oscillates between TAP A and TAP B.

At step 2, the second selection signal DIM(1) is selected between DIM(1)_0 for which the OFG is activated at the beginning of the period or DIM(1)_1 for which the OFG is activated at the end of the period. The second demodulation voltage MIX(1) oscillates between TAP A and TAP B with a higher frequency than first demodulation voltage MIX(0).

At step 3, the third selection signal DIM(2) is selected between DIM(2)_0, DIM(2)_1, DIM(2)_2, DIM(2)_3 for which each is able to activate the OFG 62 during three quarter of the measurement window (the readout from the demodulation signal is then one quarter of the measurement window). The third demodulation voltage MIX(2) oscillates between TAP A and TAP B with a higher frequency that first MIX(0) or second MIX(1) demodulation voltage.

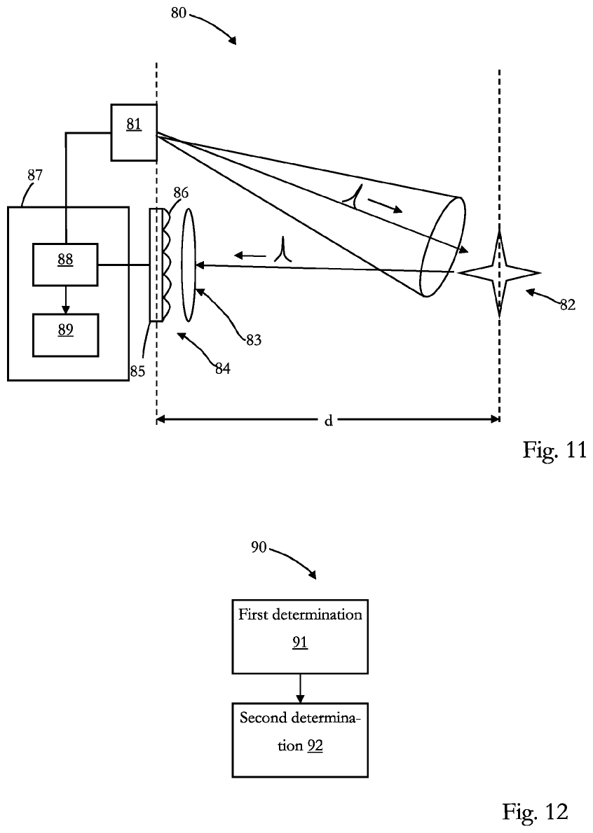

In FIG. 11, on a high level, there is illustrated an embodiment of a time-of-flight imaging system 80, which is embodied here as a ToF camera and which can be used for depth sensing or providing a distance measurement and which has time-of-flight demodulation circuitry 87 which is configured to perform the methods as discussed herein and which forms a control of the ToF apparatus 80 (and it includes, not shown, corresponding processors, memory and storage as it is generally known to the skilled person).

The ToF imaging system 80 has a pulsed light source 81 and it includes light emitting elements (based on laser diodes), wherein in the present embodiment, the light emitting elements are narrow band laser elements.

The light source 81 emits pulsed light to a scene 82 (region of interest or object), which reflects the light. By repeatedly emitting light to the scene 82, the scene 82 can be scanned, as it is generally known to the skilled person. The reflected light is focused by an optical stack 83 to a light detector 84.

The time-of-flight demodulation circuitry 87 also forms control of the light source, such that it also includes a corresponding control circuitry (not depicted).

The light detector 84 has an image sensor 85, which is implemented based on multiple TOF pixels according to the present disclosure formed in an array of pixels (imaging elements) and a microlens array 86 which focuses the light reflected from the scene 82 to the image sensor 85 (to each pixel of the image sensor 85).

The light emission time information is fed from the light source 81 to the time-of-flight demodulation circuitry 87 including a time-of-flight measurement unit 88, which also receives respective time information from the image sensor 85, when the light is detected which is reflected from the scene 82. On the basis of the emission time information received from the light source 81 and the time of arrival information received from the image sensor 85, the time-of-flight measurement unit 88 computes a round-trip time of the light emitted from the light source 81 and reflected by the scene 82 and on the basis thereon it computes a distance d (depth information) between the image sensor 85 and the scene 82 based on a determination of light events, as discussed herein.

The depth information is fed from the time-of-flight measurement unit 88 to a 3D image reconstruction unit 89 of the time-of-flight demodulation circuitry 87, which reconstructs (generates) a 3D image of the scene 82, based on the depth information received from the time-of-flight measurement unit 88.

In some embodiments, the image sensor 85 can be implemented based on multiple SPADs (Single Photon Avalanche Diodes) as it is generally known by the skilled person. The image sensor includes a matrix of SPADs could be operated analogous to an image sensor 85 which is implemented based on multiple TOF pixels according to the present disclosure but where draining (activating the overflow gate 62) is implemented such that the SPAD is kept turned OFF.

FIG. 12 depicts a block diagram of a ToF demodulation method 90 according to the present disclosure.

At 91, a first light pulse is detected with a first demodulation signal (including a first part and a second part), as discussed herein. The first demodulation signal is a rectangular signal in this embodiment.

At 92, at least one selection signal is set based on the first light pulse detection by the first demodulation signal (whether the first light pulse is detected in the first part or in the second part of the first demodulation signal), as discussed herein. In this embodiment, the selection signal phase and frequency are set, such that a second light pulse detected by a second demodulation signal will be detected but with the selection signal being configured to disable light detection during a determined time window that corresponds to a part of a previously applied demodulation signal that did not include the detected first light pulse.

At 93, the second light pulse is detected with the second demodulation signal, as discussed herein.

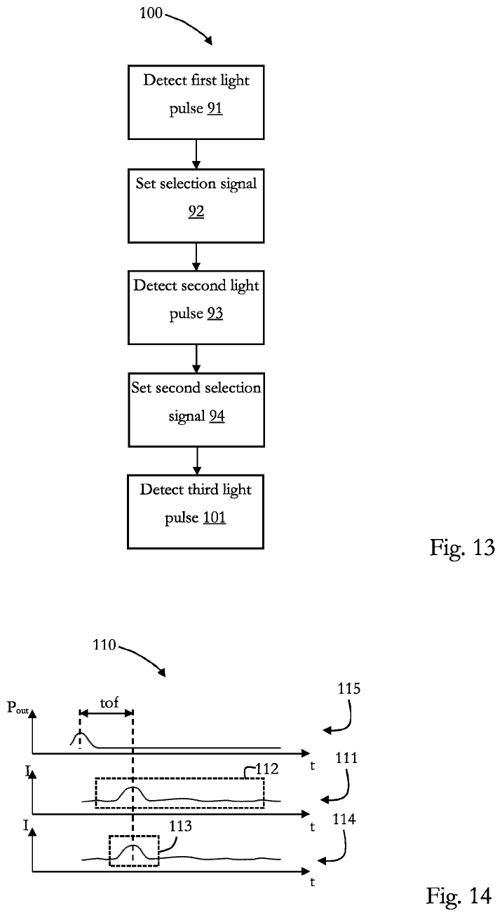

FIG. 13 depicts a block diagram of a ToF demodulation method 100 according to the present disclosure.

The ToF demodulation method 100 is different from the ToF demodulation method 90 of FIG. 12 in that, at 101, after detecting the second light pulse, a third light pulse is detected, wherein a third selection signal is set, at 94, in correspondence to the setting of the second selection signal and of the second light pulse detected at 93.

FIG. 14 is a schematic diagram 110 in which the results of the present disclosure are shown vis-à-vis known ToF devices.

A light pulse as it is detected in a known device, as depicted in diagram 111, has a frame 112 of a length which is (much) longer than a frame length of a frame 113 as acquired with ToF demodulation circuitry according to the present disclosure, as depicted in diagram 114.

Hence, the frame 113 has a shorter integration time than the frame 112, but the frame is still centered around the light pulse, such that a noise is decreased since less ambient light is integrated.

The diagrams 111 and 114 have a current as measured on an imaging element on an ordinate, which is plotted versus a time t.

Moreover, a diagram 115 is shown depicting an emitted light signal as discussed herein. A light pulse (of the light signal) with a power Pₒᵤₜ is reflected to an imaging element with a certain intensity and a delay (the time of flight, as discussed herein).

It should be recognized that the embodiments describe methods with an exemplary ordering of method steps. The specific ordering of method steps is however given for illustrative purposes only and should not be construed as binding. For example, the ordering of 93 and 101 in the embodiment of FIG. 13 may be exchanged. Further, also the ordering of 46 and 51 in the embodiment of FIG. 4 may be exchanged. Other changes of the ordering of method steps may be apparent to the skilled person.

Please note that the division of the ToF demodulation circuitry 87 into units 88 and 89 is only made for illustration purposes and that the present disclosure is not limited to any specific division of functions in specific units. For instance, the ToF demodulation circuitry 87 could be implemented by a respective programmed processor, field programmable gate array (FPGA) and the like.

The methods can also be implemented as a computer program causing a computer and/or a processor, to perform the methods, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) Time-of-flight demodulation circuitry configured to:
carry out a first determination and a second determination, the first determination comprising:
   integrating a light signal demodulated with a first mixing signal into a first integrated demodulated signal; and
   set a selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination comprising:
   integrating the light signal demodulated with the second mixing signal into the second integrated demodulated signal based on the selection signal.

(2) The time-of-flight demodulation circuitry of (1), further configured to:
apply the second mixing signal and the second mixing signal during the second determination.

(3) The time-of-flight demodulation circuitry of (1) or (2), wherein the selection signal is configured to selectively disable the demodulated light signal integration with the second mixing signal.

(4) The time-of-flight demodulation circuitry of anyone of (1) to (3), further configured to: output a digital signal for each determination being indicative of a pulse location.

(5) The time-of-flight demodulation circuitry of anyone of (1) to (4), further configured to: carry out an analog indirect time-of-flight pulsed measurement at a maximum measurement frequency, thereby matching a pulse length to half a period of the maximum measurement frequency.

(6) The time-of-flight demodulation circuitry of anyone of (1) to (5), further configured to: carry out the first and the second determination when a signal loss is determined.

(7) The time-of-flight demodulation circuitry of (6), wherein the signal loss is detected by comparing a norm of multiple time-of-flight measurements.

(8) The time-of-flight demodulation circuitry of (6) or (7), wherein the signal loss is detected by checking continuity of depth values over multiple measurements.

(9) The time-of-flight demodulation circuitry of anyone of (1) to (8), further configured to:
adjust a zoom window at a highest frequency based on a measured location of a light pulse, the adjustment including moving forward the zoom window, if the pulse lies within a second half of the zoom window, and moving backward if the pulse lies within a first half of the zoom window.

(10) The time-of-flight demodulation circuitry of anyone of (1) to (9), wherein the selection signal is used for disabling detection of light pulses with the mixing signals in a first part of the respective mixing signal and to allow detection of light pulses with mixing signals in a second part of the respective mixing signal.

(11) The time-of-flight demodulation circuitry of anyone of (1) to (10), wherein the second mixing signal has a frequency higher than or equal to the selection signal.

(12) The time-of-flight demodulation circuitry of anyone of (1) to (11), wherein the selection signal is set in such a way that a light pulse is detected in a predetermined part of the second mixing signal.

(13) The time-of-flight demodulation circuitry of anyone of (1) to (12), wherein the first mixing signal includes a first part and a second part; and
wherein the selection signal is set based on whether the light pulse is mainly detected in the first part or in the second part of the first mixing signal.

(14) The time-of-flight-demodulation circuitry of anyone of (1) to (13), wherein the second demodulation signal has a double frequency than the first demodulation signal.

(15) The time-of-flight demodulation circuitry of anyone of (1) to (14), further configured to:
use a second selection signal for disabling detection of light, the second selection signal being set based on the second integrated demodulated signal; and
carry out a third determination including:
   integrating the light signal demodulated with a third mixing signal into a third
   integrated demodulated signal based on the second selection signal.

(16) The time-of-flight demodulation circuitry of (15), wherein the first, second, and third mixing signals are based on a Gray code.

(17) The time-of-flight demodulation circuitry of anyone of (1) to (16), wherein the mixing signals and selection signals are rectangular signals.

(18) The time-of-flight demodulation circuitry of anyone of (1) to (17), wherein the first and the second light pulses are detected by folding the light signal with the respective mixing signal.

(19) A time-of-flight demodulation method comprising:
carrying out a first determination and a second determination, the first determination including:
   integrating a light signal demodulated with a first mixing signal into a first integrated demodulated signal; and
   setting a selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination including:
   integrating the light signal demodulated with the second mixing signal into the second integrated demodulated signal based on the selection signal.

(20) A time-of-flight device comprising:
a light source;
at least one light detection element configured to generate an electric signal in response to a detection of light being emitted from the light source and reflected at a scene, the light detection element comprising an overflow gate configured to selectively disable the detection of light by applying a selection signal; and
time-of-flight demodulation circuitry configured to:
carry out a first determination and a second determination, the first determination comprising:
   integrating the light signal demodulated with a first mixing signal into a first integrated demodulated signal; and
   set the selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination comprising:
   integrating the light signal demodulated with the second mixing signal into the second integrated demodulated signal based on the selection signal.

1. Time-of-flight demodulation circuitry configured to:
carry out a first determination and a second determination, the first determination comprising:
integrating a light signal demodulated with a first mixing signal into a first integrated demodulated signal; and
set a selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination comprising:
integrating the light signal demodulated with the second mixing signal into the second integrated demodulated signal based on the selection signal.

2. The time-of-flight demodulation circuitry of claim 1, further configured to:
applying the second mixing signal and the second mixing signal during the second determination.

3. The time-of-flight demodulation circuitry of claim 1, wherein the selection signal is configured to selectively disable the demodulated light signal integration with the second mixing signal.

4. The time-of-flight demodulation circuitry of claim 1, further configured to:
output a digital signal for each determination being indicative of a pulse location.

5. The time-of-flight demodulation circuitry of claim 1, further configured to:
carry out an analog indirect time-of-flight pulsed measurement at a maximum measurement frequency, thereby matching a pulse length to half a period of the maximum measurement frequency.

6. The time-of-flight demodulation circuitry of claim 1, further configured to:
carry out the first and the second determination when a signal loss is determined.

7. The time-of-flight demodulation circuitry of claim 6, wherein the signal loss is detected by comparing a norm of multiple time-of-flight measurements.

8. The time-of-flight demodulation circuitry of claim 6, wherein the signal loss is detected by checking continuity of depth values over multiple measurements.

9. The time-of-flight demodulation circuitry of claim 1, further configured to:
adjust a zoom window at a highest frequency based on a measured location of a light pulse, the adjustment including moving forward the zoom window, if the pulse lies within a second half of the zoom window, and moving backward if the pulse lies within a first half of the zoom window.

10. The time-of-flight demodulation circuitry of claim 1, wherein the selection signal is used for disabling detection of light pulses with the mixing signals in a first part of the respective mixing signal and to allow detection of light pulses with mixing signals in a second part of the respective mixing signal.

11. The time-of-flight demodulation circuitry of claim 1, wherein the second mixing signal has a frequency higher than or equal to the selection signal.

12. The time-of-flight demodulation circuitry of claim 1, wherein the selection signal is set in such a way that a light pulse is detected in a predetermined part of the second mixing signal.

13. The time-of-flight demodulation circuitry of claim 1, wherein the first mixing signal includes a first part and a second part; and
wherein the selection signal is set based on whether the light pulse is mainly detected in the first part or in the second part of the first mixing signal.

14. The time-of-flight-demodulation circuitry of claim 1, wherein the second demodulation signal has a double frequency than the first demodulation signal.

15. The time-of-flight demodulation circuitry of claim 1, further configured to:
use a second selection signal for disabling detection of light, the second selection signal being set based on the second integrated demodulated signal; and
carry out a third determination including:
integrating the light signal demodulated with a third mixing signal into a third integrated demodulated signal based on the second selection signal.

16. The time-of-flight demodulation circuitry of claim 15, wherein the first, second, and third mixing signals are based on a Gray code.

17. The time-of-flight demodulation circuitry of claim 1, wherein the mixing signals and selection signals are rectangular signals.

18. The time-of-flight demodulation circuitry of claim 1, wherein the first and the second light pulses are detected by folding the light signal with the respective mixing signal.

19. A time-of-flight demodulation method comprising:
carrying out a first determination and a second determination, the first determination including:
integrating a light signal demodulated with a first mixing signal into a first integrated demodulated signal; and
setting a selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination including:
integrating the light signal demodulated with the second mixing signal into the second integrated demodulated signal based on the selection signal.

20. A time-of-flight device comprising:
a light source;
at least one light detection element configured to generate an electric signal in response to a detection of light being emitted from the light source and reflected at a scene, the light detection element comprising an overflow gate configured to selectively disable the detection of light by applying a selection signal; and
time-of-flight demodulation circuitry configured to:
carry out a first determination and a second determination, the first determination comprising:
integrating the light signal demodulated with a first mixing signal into a first integrated demodulated signal; and
set the selection signal for disabling detection of light, the selection signal being set based on the first integrated demodulated signal for integrating, in the second determination, the light signal demodulated with a second mixing signal into a second integrated demodulated signal for a shorter time period than in the first determination;
the second determination comprising:
integrating the light signal demodulated with the second mixing signal into the second integrated demodulated signal based on the selection signal.
